(19) United States
(12) Patent Application Publication
(10) Pub. No.: US 2026/0309018 A1
(43) Pub. Date: Oct. 8, 2026

(54) GAS SEPARATOR FOR ELECTRICAL SUBMERSIBLE PUMP

(71) Applicant: Halliburton Energy Services, Inc., Houston, TX (US)

(72) Inventors: Ketankumar Kantilal Sheth, Tulsa, OK (US); Donn Jason Brown, Tulsa, OK (US); Trevor Alan Kopecky, Tulsa, OK (US)

(21) Appl. No.: 19/173,492

(22) Filed: Apr. 8, 2025

(51) Int. Cl. E21B 43/38; B01D 19/00; F04D 1/06; F04D 13/10

(52) U.S. Cl. CPC E21B 43/38; B01D 19/0057; F04D 1/06; F04D 13/10

(57) ABSTRACT

A gas separator for an electrical submersible pump includes a housing defining an inlet at a first axial end of the housing and an outlet at a second axial end of the housing; a drive shaft extending axially through the housing; a fluid reservoir defined by the housing and disposed downstream of the inlet; a paddlewheel affixed to the drive shaft and disposed downstream of the fluid reservoir; and a crossover comprising a skirt, disposed downstream of the helical auger, and providing fluid communication between an interior of the housing and an exterior of the housing.

### BACKGROUND

Conventional mechanical gas separators for electrical submersible pumps may use some type of fluid mover at the entrance of the separator to impart energy to the incoming fluid. The fluid mover can be a centrifugal mover, an axial stage, or a positive displacement type rotating auger. This can require added horse power from the motor and added length to accommodate the fluid mover. The gas separator of the present disclosure may address one or more of these issues.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic diagram of an electrical submersible pump (ESP) assembly, according to an embodiment of the present disclosure;

FIG. 2 is a perspective view of a tandem gas separator system for an electrical submersible pump, according to an embodiment;

FIG. 3 is a perspective view of a gas separator for an electrical submersible pump, according to an embodiment;

FIG. 4 is a side cross sectional view of a gas separator for an electrical submersible pump, according to an embodiment;

FIG. 5 is a side cross sectional view of a gas separator for an electrical submersible pump, according to another embodiment;

FIG. 6 is a side cross sectional view of a gas separator for an electrical submersible pump, according to yet another embodiment;

FIG. 7 is a side cross sectional view of a gas separator for an electrical submersible pump, according to yet another embodiment;

FIG. 8 is a flow diagram of a method of assembling an electrical submersible pump, according to an embodiment;

FIG. 9 is a flow diagram of a method for lifting fluid in a wellbore, according to an embodiment; and

FIG. 10 is a side cross sectional view of a gas separator for an electrical submersible pump, according to an embodiment.

### DETAILED DESCRIPTION

It should be understood at the outset that although illustrative implementations of one or more embodiments are illustrated below, the disclosed systems and methods may be implemented using any number of techniques, whether currently known or not yet in existence. The description that follows includes example systems, methods, techniques, and program flows that embody aspects of the disclosure. However, it is understood that this disclosure may be practiced without these specific details. For brevity, well-known steps, protocols, structures, and techniques have not been shown in detail in order not to obfuscate the description. The disclosure should in no way be limited to the illustrative implementations, drawings, and techniques illustrated below, but may be modified within the scope of the appended claims along with their full scope of equivalents.

As used herein the terms “uphole”, “upwell”, “above”, “top”, and the like refer directionally in a wellbore towards the surface, while the terms “downhole”, “downwell”, “below”, “bottom”, and the like refer directionally in a wellbore towards the toe of the wellbore (e.g. the end of the wellbore distally away from the surface), as persons of skill will understand. Orientation terms “upstream” and “downstream” are defined relative to the direction of flow of fluid, for example relative to flow of well fluid in the well. As used herein, orientation terms “upstream,” “downstream,” “up,” and “down” are defined relative to the direction of flow of well fluid in the well casing. “Upstream” is directed counter to the direction of flow of well fluid, towards the source of well fluid (e.g., towards perforations in well casing through which hydrocarbons flow out of a subterranean formation and into the casing). “Downstream” is directed in the direction of flow of well fluid, away from the source of well fluid. “Down” is directed counter to the direction of flow of well fluid, towards the source of well fluid. “Up” is directed in the direction of flow of well fluid, away from the source of well fluid.

The gas separator of the present disclosure may utilize the kinetic energy from a lower gas separator in a gas separator tandem assembly to effectively separate gas from liquid without the need to impart axial momentum to the fluid inside the gas separator. Because fluids may be forced directly into the gas separator, the fluid may flow through the gas separator with the liquid being directed to the centrifugal pump assembly and the gas being vented to the annulus. A separation chamber in the gas separator may include, for example, a static helical auger or a paddle wheel. Because these components do not impart axial momentum to the fluid, the length of the gas separator (and therefore the ESP) may be reduced and the overall efficiency of the ESP may be improved as compared with the conventional art.

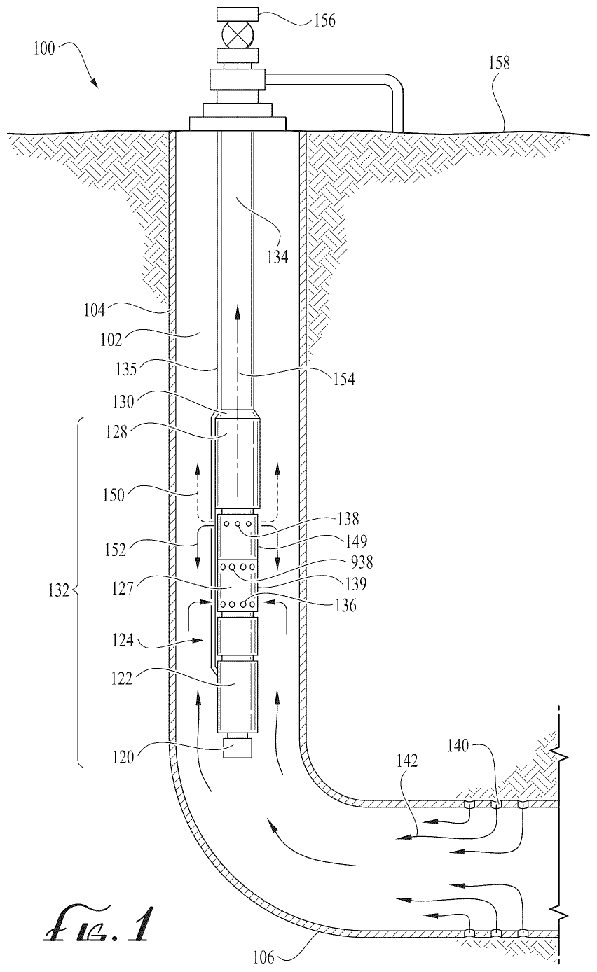

Referring to FIG. 1, a well site environment 100, according to one or more aspects of the disclosure, is described. The well site environment 100 comprises a wellbore 102 that is at least partially cased with casing 104. As depicted in FIG. 1, the wellbore 102 has a deviated or horizontal portion 106, but the electric submersible pump (ESP) assembly 132 described herein may be used in a wellbore 102 that does not have a deviated or horizontal portion 106. The well site environment 100 may be at an on-shore location or at an off-shore location. The ESP assembly 132 in an embodiment comprises a sensor package 120, an electric motor 122, a seal unit 124, a tandem gas separator system 127, and a centrifugal pump assembly 128. The centrifugal pump assembly may couple to a production tubing 134 via a connector 130. An electric cable 135 may attach to the electric motor 122 and extend to the surface 158 to connect to an electric power source. The tandem gas separator system 127 may include inlet ports 136 and gas phase discharge ports 138, 938. The casing 104 and/or wellbore 102 may have perforations 140 that allow reservoir fluid 142 to pass from the subterranean formation through the perforations 140 and into the wellbore 102.

The reservoir fluid 142 may flow uphole towards the ESP assembly 132 and into the inlet ports 136. The reservoir fluid 142 may comprise a liquid phase fluid. The reservoir fluid 142 may comprise a gas phase fluid mixed with a liquid phase fluid. The reservoir fluid 142 may comprise only a gas phase fluid (e.g., simply gas). Over time, the gas to fluid ratio of the reservoir fluid 142 may change dramatically. For example, in the horizontal portion 106 of the wellbore gas may build up in high points in the roof of the wellbore 102 and after accumulating sufficiently may “burp” out of these high points and flow downstream to the ESP assembly 132 as what is commonly referred to as a gas slug. Thus, immediately before a gas slug arrives at the ESP assembly 132, the gas fluid ratio of the reservoir fluid 142 may be very low (e.g., the reservoir fluid 142 at the ESP assembly 132 is mostly liquid phase fluid); when the gas slug arrives at the ESP assembly 132, the gas fluid ratio is very high (e.g., the reservoir fluid 142 at the ESP assembly 132 is entirely or almost entirely gas phase fluid); and after the gas slug has passed the ESP assembly 132, the gas fluid ratio may again be very low (e.g., the reservoir fluid 142 at the ESP assembly 132 is mostly liquid phase fluid).

Under normal operating conditions (e.g., reservoir fluid 142 is flowing out of the perforations 140, the ESP assembly 132 is energized by electric power, the electric motor 122 is turning, and a gas slug is not present at the ESP assembly 132), the reservoir fluid 142 enters the inlets 136, the reservoir fluid 142 is separated by the tandem gas separator system 127 into a gas phase fluid (or a mixed-phase fluid having a higher gas liquid ratio than the reservoir fluid 142 entering the inlet ports 136) and a liquid phase fluid (or a mixed-phase fluid having a lower gas liquid ratio than the reservoir fluid 142 entering the inlet ports 136). The gas phase fluid is discharged via the gas phase discharge ports 138, 938, and the liquid phase fluid is flowed downstream to the centrifugal pump assembly 128 as liquid phase fluid 154. Under normal operating conditions, the gas phase fluid that is discharged into the annulus between the casing 104 and the outside of the ESP assembly 132 may comprise both gas phase fluid 150 that rises uphole in the wellbore 102 and liquid phase fluid 152 that falls downhole in the wellbore 102. The centrifugal pump assembly 128 flows the liquid phase fluid 154 (e.g., a portion of the reservoir fluid 142) up the production tubing 134 to a wellhead 156 at the surface 158.

In an embodiment, the centrifugal pump assembly 128 comprises one or more centrifugal pump stages, where each stage comprises an impeller that is mechanically coupled to a drive shaft within the centrifugal pump assembly 128 and a corresponding diffuser that is stationary and retained by a housing of the centrifugal pump assembly 128. In an embodiment, the impellers may comprise a keyway that mates with a corresponding keyway on the drive shaft of the centrifugal pump assembly 128 and a key may be installed into the two keyways, wherein the impeller may be mechanically coupled to the drive shaft of the centrifugal pump assembly.

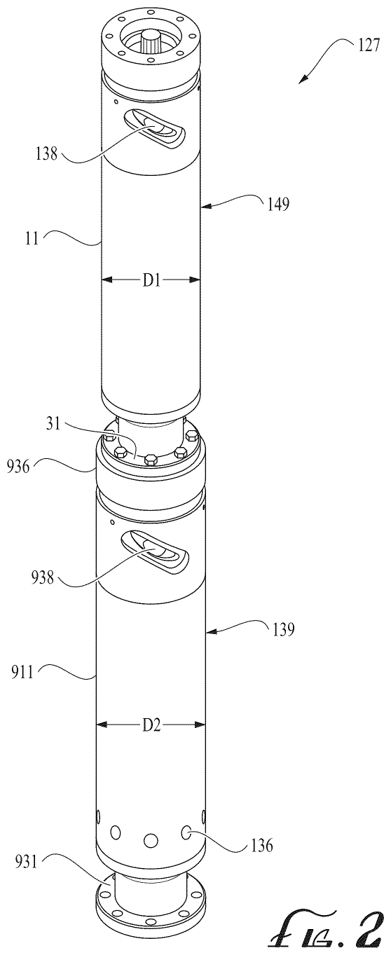

Referring to FIG. 2, the tandem gas separator system 127 may include a first gas separator 139 and a second gas separator 149 affixed to the first gas separator 139 such that a housing 11 of the second gas separator 149 is in fluid communication with the housing 911 of the first gas separator 139. For example, a crossover of the first gas separator 139 may be threaded into a head flange 936 of the first gas separator 139, which may be bolted to a base flange 31 of the second gas separator 149, which may be threaded into the housing 11 of the second gas separator 149 in a tandem separator configuration. Thus, fluid passing from the housing 911 of the first gas separator 139 to the housing 11 of the second separator 126B may pass through the crossover of the first gas separator 139, the head flange 936 of the first gas separator 139, the base flange 31 of the second gas separator 149, and into the housing 11 of the second gas separator 149. In other embodiments, the first gas separator 139 may be formed of a housing 911 with a crossover threaded into the end of the housing 911, and a head flange 936 threaded into the end of the crossover. Thus, in some embodiments, the housing 911 does not enclose or surround the crossover.

The second gas separator 149 may be disposed downstream of the first gas separator 139. A diameter D1 of a housing 11 of the second gas separator 149 may be smaller than a diameter D2 of the housing 911 of the first gas separator 139. This may be advantageous in that the smaller diameter D1 may result in a relatively lower velocity of fluid passing over the housing 11 of the second gas separator 149 as compared with the velocity of fluid passing over the housing 911 of the first gas separator 139 in the annulus, which may allow entrained bubbles to more easily rise to the surface.

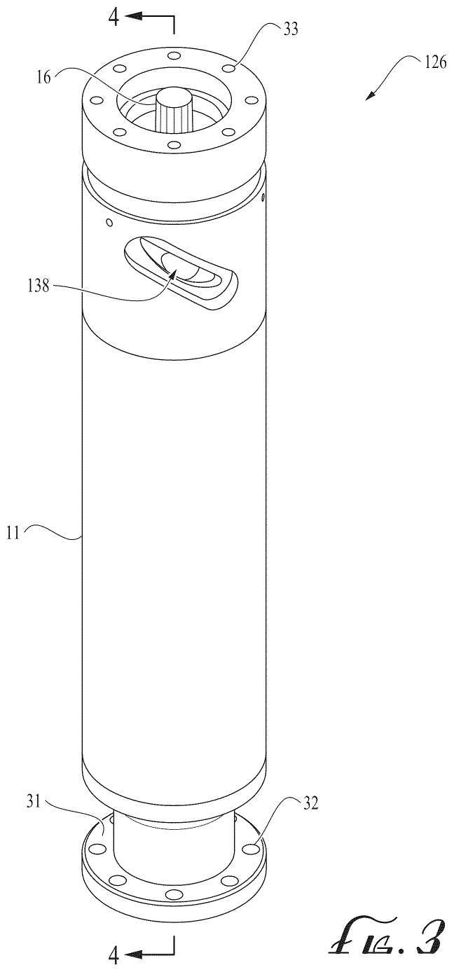

Referring to FIG. 3, a gas separator 126 is provided (which may be the second gas separator 149 shown in FIG. 2). The gas separator 126 may be generally cylindrical and include a gas phase discharge port 138. A drive shaft 16 may pass through the gas separator 126. The gas separator 126 may include a flange 31 at a first side of the gas separator 126. The flange 31 may include holes 32 for bolts for connection to a seal unit or another gas separator. There may be holes 33 at an opposite end of the gas separator 126 for bolts for connection to another gas separator or a centrifugal pump assembly 128.

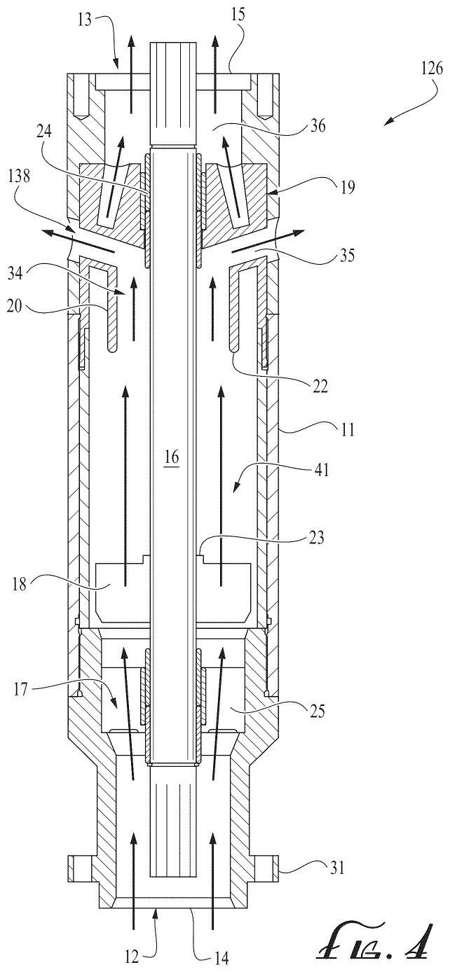

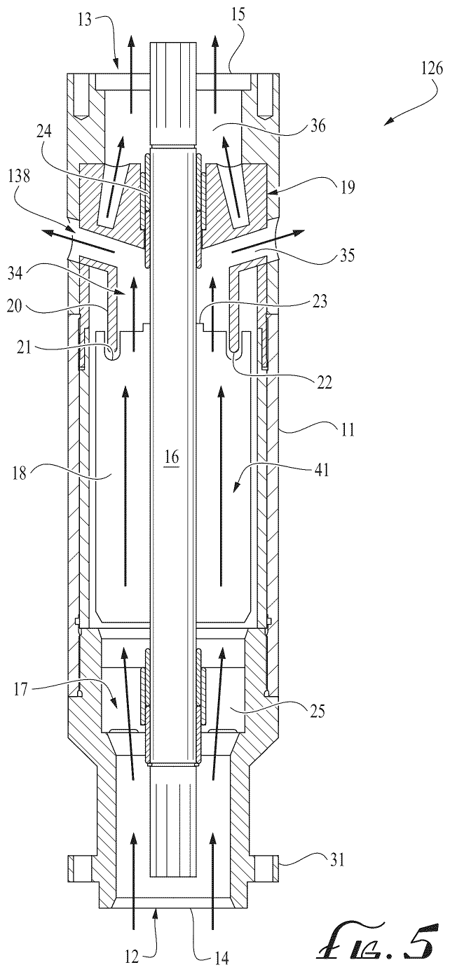

Referring to FIGS. 4-5, a gas separator 126 (which may be the second gas separator 149 shown in FIG. 2) for an electrical submersible pump may include a housing 11 defining an inlet 12 at a first axial end 14 of the housing 11 and an outlet 13 at a second axial end 15 of the housing 11; a drive shaft 16 extending axially through the housing 11; a fluid reservoir 17 within the flange 31 of the gas separator 126 and disposed downstream of the inlet 12; a paddlewheel 18 affixed to the drive shaft 16 and disposed downstream of the fluid reservoir 17; and a crossover 19 comprising a skirt 20, disposed downstream of the paddlewheel 18, and providing fluid communication between an interior of the housing 11 and an exterior of the housing 11. The paddlewheel 18 may be disposed in a separator chamber 41. The fluid reservoir 17 may have a larger cross sectional area than the inlet 12. The volume occupied by the paddlewheel 18 may have a larger cross sectional area than the fluid reservoir 17. The paddlewheel 18 may be of any configuration that imparts circumferential momentum to the fluid without imparting axial momentum to the fluid. There may be a small gap between the paddlewheel 18 and the housing 11. The skirt 20 may define a crossover fluid passageway 34 that has a smaller cross sectional area than the volume occupied by the paddlewheel. The skirt 20 may extend upstream away from the outlet. The crossover 19 may include gas discharge port 35 open to an exterior of the gas separator 126 and a liquid phase discharge port 36 open to the outlet 13. The skirt 20 may help capture or segregate the gas to prevent it from being remixed into the liquid. The annulus between the skirt 20 and the housing 11 forms a channel directing liquid phase fluid into the liquid phase discharge ports 36.

In some embodiments, gas separator 126 does not comprise a rotating component configured to impart axial momentum to fluid. In some embodiments, the housing 11 does not contain any rotating components other than the drive shaft 16 and the paddlewheel 18. This may be advantageous for increased efficiency and decreased length. The increase in efficiency may be a result of reduced horsepower load on the motor 122.

The crossover 19 may include a bushing 24 configured to allow the drive shaft 16 to rotate within the crossover 19. The gas separator 126 may include a spider bearing 25 disposed within the fluid reservoir 17. The spider bearing 25 may be affixed to the housing 11 and configured to allow the drive shaft 16 to rotate within the spider bearing 25. Each of the spider bearings 25 may include two or more vanes.

In some embodiments, the paddlewheel 18 is axially spaced apart from the skirt 20 of the crossover 19 (see FIG. 4). The skirt 20 may be a tube defining the crossover fluid passageway 34. In some embodiments, the paddlewheel 18 comprises a notch 21 configured to accommodate at least a portion of the skirt 20 such that an end 22 of the skirt 20 is disposed upstream of an end 23 of the paddlewheel 18 (see FIG. 5). That is, the end of the skirt 20 may be disposed at least partially inside the notch 21. In some embodiments, the skirt 22 may extend upstream from the gas discharge port 35. In some embodiments, an angle between the skirt 22 and the gas discharge port 35 is greater than 90 degrees and/or less than 180 degrees. The skirt 22 may be tubular in shape. There may be a gap between the skirt 22 and the housing 11. The skirt 22 may surround the shaft 16 and/or be concentric with the shaft 16. There may be a gap between the skirt 22 and the shaft 16, allowing for fluid flow from the separation chamber 41 to the gas discharge port 35.

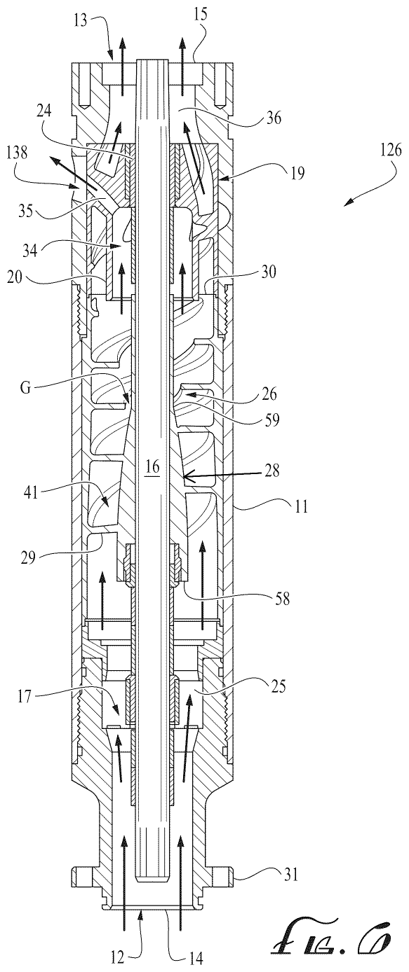

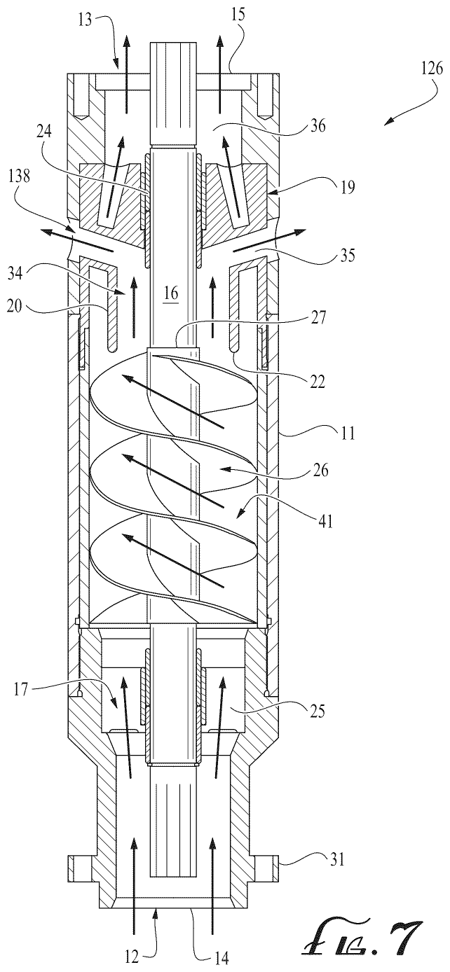

Referring to FIGS. 6 and 7 (which may be the second gas separator 149 shown in FIG. 2), a gas separator 126 for an electric submersible pump may include a housing 11 defining an inlet 12 at a first axial end 14 of the housing 11 and an outlet 13 at a second axial end 15 of the housing 11; a drive shaft 16 extending axially through the housing 11; a fluid reservoir 17 defined by the housing 11 and/or flange 31 and disposed downstream of the inlet 12; a helical auger 26 affixed to the housing 11 and disposed downstream of the fluid reservoir 17; and a crossover 19 comprising a skirt 20, disposed downstream of the helical auger 26, and providing fluid communication between an interior of the housing 11 and an exterior of the housing 11. The embodiments of FIGS. 6-7 may contain some of the same structure as the embodiments of FIGS. 4-5, which for the sake of brevity will not all be repeated here.

In some embodiments, the gas separator 126 does not comprise a rotating component other than the drive shaft 16. In some embodiments, the housing 11 does not contain any rotating components other than the drive shaft 16.

An end 27 of the helical auger 26 may be level with an end 22 of the skirt. The crossover 19 may include a bushing 24 configured to allow the drive shaft 16 to rotate within the crossover 19. The gas separator 126 may include a spider bearing 25 disposed within the fluid reservoir 17. The spider bearing 25 may be affixed to the housing 11 and configured to allow the drive shaft 16 to rotate within the spider bearing 25, which may have two or more vanes. In some embodiments, the crossover 19 comprises a spiraled flow path at the entrance of the crossover 19 (e.g., to maintain kinetic energy and reduce erosion), which straightens downstream.

Referring to FIG. 6, the gas separator 126 may include a tapered hub 28 disposed at least partially within the helical auger 26. In some embodiments, the tapered hub 28 may be integrally formed with the helical auger 26. A pitch angle of the helical auger 26 may decrease progressively from a first end 29 of the helical auger 26 to a second end 30 of the helical auger 26. In some embodiments, there may be a gap G, between the helical auger 26 and the drive shaft 16. The gap G may span from a downstream end 59 of the tapered hub 28 to the second end 30 of the auger downstream from the tapered hub 28. In some embodiments, an upstream end 58 of the tapered hub 28 is farther upstream than the first end 29 of the helical auger 26.

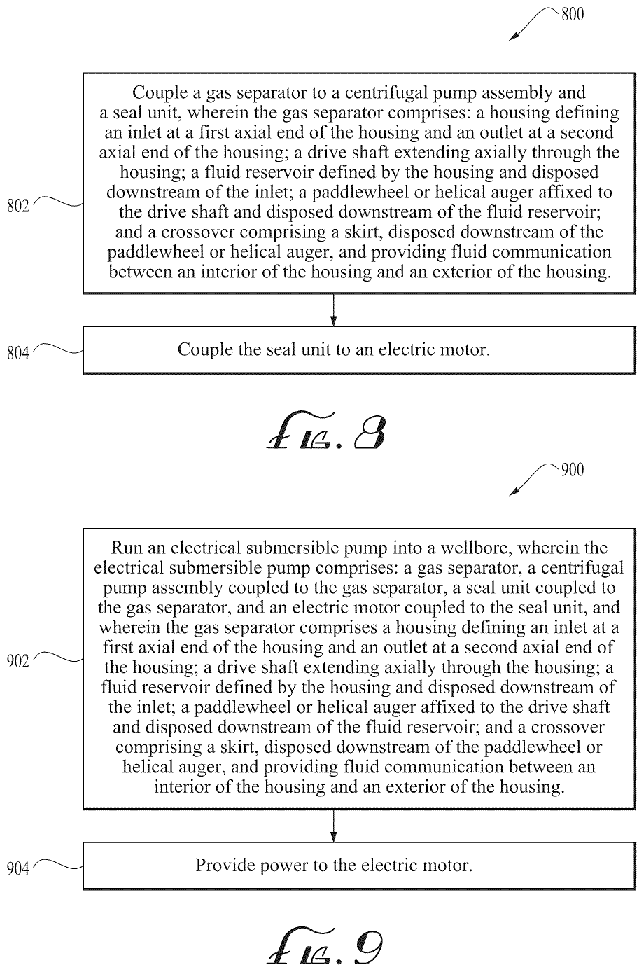

Referring to FIG. 8, a method 800 of assembling an electric submersible pump may include the step 802 of coupling a gas separator to a centrifugal pump assembly and a seal unit; and the step 804 of coupling the seal unit to an electric motor. The gas separator may include a housing defining an inlet at a first axial end of the housing and an outlet at a second axial end of the housing; a drive shaft extending axially through the housing; a fluid reservoir defined by the housing and disposed downstream of the inlet; a paddlewheel or helical auger affixed to the drive shaft and disposed downstream of the fluid reservoir; and a crossover comprising a skirt, disposed downstream of the paddlewheel or helical auger, and providing fluid communication between an interior of the housing and an exterior of the housing.

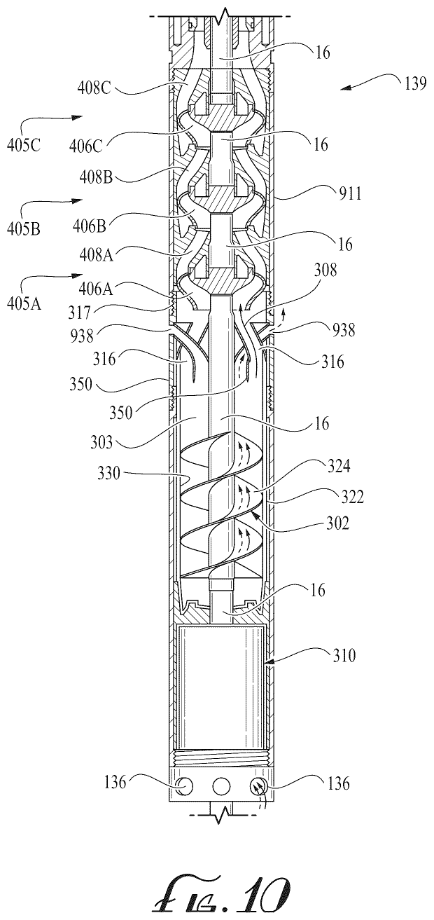

Referring to FIG. 9, a method 900 of lifting fluid in a wellbore may include the step 902 of running an electric submersible pump into a wellbore, wherein the electric submersible pump comprises a gas separator, a centrifugal pump assembly coupled to the gas separator, a seal unit coupled to the gas separator, and an electric motor coupled to the seal unit; and the step 904 of providing power to the electric motor. The gas separator may include a housing defining an inlet at a first axial end of the housing and an outlet at a second axial end of the housing; a drive shaft extending axially through the housing; a fluid reservoir defined by the housing and disposed downstream of the inlet; a paddlewheel or helical auger affixed to the drive shaft and disposed downstream of the fluid reservoir; and a crossover comprising a skirt, disposed downstream of the paddlewheel or helical auger, and providing fluid communication between an interior of the housing and an exterior of the housing. The method 900 may further include capturing and segregating fluid flow by the skirt.

Referring to FIG. 10, a gas separator 139 (which may be the first gas separator 139 shown in FIG. 2) for an electrical submersible pump is shown. The first gas separator 139 may be an integrated gas separator and pump assembly. The first gas separator 139 may include a housing 911. The gas separator 139 may include a fluid mover 310, a stationary auger 302 and one or more gas phase discharge ports 938. The fluid mover 310 may be any type of fluid mover configured to impart axial momentum to the fluid, for example, an auger mechanically coupled to the drive shaft 16, an impeller mechanically coupled to the drive shaft, or an impeller and a diffuser system (e.g., where the impeller of the system is mechanically coupled to the drive shaft 16). The one or more inlet ports 136 allow intake of fluid from annulus 210 into the fluid mover 310 which communicates or flows the fluid to the stationary auger 302.

The drive shaft 16 may extend through the fluid mover 310, through the stationary auger 302, through one or more centrifugal pump stages 405 to couple to the drive shaft 376 to drive the centrifugal pump stages 405. In some embodiments, the fluid mover 310 is mechanically coupled to the drive shaft 16 and is hence turned by the electric motor. An impeller 406 of each of one or more centrifugal pump stages 405 may be mechanically coupled to the drive shaft 16 and hence turned by the electric motor 116. The stationary auger 302 may be disposed or positioned within a sleeve 330. The fluid mover 310 may couple to the sleeve 330 at a downhole or distal end of the sleeve 330. In some embodiments, the stationary auger 302, the sleeve 330 or both are fluidically coupled to the one or more inlet ports 136 (e.g., fluidically coupled to the inlet ports 136 via the fluid mover 310). For example, the sleeve 330, the stationary auger 302 or both may be coupled to the fluid mover 310 via a support or other device including, but not limited to, the drive shaft 16. The fluid mover 310 may communicate or force fluid received at the one or more inlet ports 136 through the sleeve 330, through the stationary auger 302, or through both. In some embodiments, an outside edge of the stationary auger 302 engages sealingly with the sleeve 330, and the flow of fluid through the sleeve 330 is hence confined to helical vanes 324 of the passageway defined by the stationary auger 302. The sleeve 330 may be disposed or positioned within the housing 911. The sleeve 330 may be secured inside the housing 911. In an embodiment, the stationary auger 302 and the sleeve 330 may be built or manufactured as a single component.

In some embodiments, the stationary auger 302 comprises one or more helixes or vanes 324. In one or more embodiments, the helixes or vanes 324 may be crescent-shaped. In some embodiments, the stationary auger 302 comprises one or more helixes or vanes 324 disposed about a solid core or an open core (for example, a careless auger or an auger (lighting)). The stationary auger 302 may cause the fluid to be separated into a liquid phase 308 and gas phase based, at least in part, on rotational flow of the fluid. For example, the one or more helixes or vanes 324 may impart rotation to the fluid as the fluid flows through, across or about the one or more helixes or vanes 324. For example, fluid mover 310 forces the fluid at a velocity or flow rate into the sleeve 330 and up or across the one or more helixes or vanes 324 of stationary auger 302.

The rotation of the fluid induced by the stationary auger 302 may be based, at least in part, on the velocity or flow rate of the fluid from the fluid mover 310. For example, the fluid mover 310 may increase the flow rate or velocity of the fluid to increase rotation of the fluid through the stationary auger 302 to create a more efficient and effective separation of the fluid into a plurality of phases, for example, a liquid phase 308 and a gas phase. As the fluid flows through the stationary auger 302 it enters a separation chamber 303 and is moving with rotating motion. Centrifugal forces, static friction or both, cause the heavier component of the fluid, a liquid phase 308, to circulate along an outer perimeter of the separation chamber while the lighter component of the fluid, the gas phase, is circulated along an inner perimeter of the separation chamber. In one or more embodiments, fluid may begin to separate into a gas phase and a liquid phase 308 while flowing through stationary auger 302.

In some embodiments, the separated fluid (for example, liquid phase 308 and gas phase) is directed to a crossover 350. For example, the crossover 350 may be disposed or positioned at an uphole or a proximal end of the separation chamber 303 or the housing 911. In some contexts, the crossover 350 may be referred to as a gas flow path and liquid flow path separator. The crossover 350 may be said to have an inlet that is fluidically coupled to an outlet of the fluid mover 310 (e.g., via fluidically coupled via the stationary auger 302 (or other fluid mover, such as a paddle wheel) and via the separation chamber 303), to have a gas phase discharge port open to the annulus 210 defined between the inside of the wellbore and an outside diameter of the ESP assembly, and to have a liquid phase discharge port open to or fluidically coupled to (e.g., via the intermediary of the centrifugal pump stages 405) an inlet of the centrifugal pump assembly 108. For example, the crossover 350 may fluidically couple the separation chamber 303 or otherwise direct one or more components or phases of fluid to the centrifugal pump assembly 108 (e.g., liquid phase fluid) and to the annulus (e.g., gas phase fluid).

The crossover 350 may comprise a plurality of channels or define a plurality of channels, for example, a gas phase discharge port 938 (a first pathway) and a liquid phase discharge port 316 (a second pathway). A gas phase of the fluid may be discharged through the gas phase discharge port 938, and a liquid phase 308 of the fluid may be discharged through the liquid phase discharge port 316. In some embodiments, any one or more of the gas phase discharge ports 938 and the one or more liquid phase discharge ports 316 may be defined by a channel or pathway having an opening, for example, a teardrop shaped opening, a round opening, an elliptical opening, a triangular opening, a square opening, or another shaped opening.

It is understood that under some operating conditions, the fluid discharged by the gas phase discharge port 938 may be partially gas phase fluid and partially liquid phase fluid. Under some operating conditions, the fluid discharged by the gas phase discharge port 938 may be mostly or entirely liquid phase fluid, for example when the ESP assembly is receiving fluid that has little gas phase content or no gas phase content. In an embodiment, much more fluid may be received into the inlet ports 136 than is delivered via the liquid phase discharge ports 316 to the inlet of the centrifugal pump assembly 108. In other words, fluid may flow out of the liquid phase discharge port 316 to the inlet of the centrifugal pump assembly 108. It is understood that under some operating conditions, the fluid discharged by the liquid phase discharge port 316 may be partially gas phase fluid and partially liquid phase fluid.

It is to be understood that the structure of parts described with respect to the first gas separator 139 may also apply to the second gas separator 149. Referring to FIG. 3, advantageously, because of the axial kinetic energy imparted by the 405 centrifugal pump stages of the first gas separator 139, the second gas separator 149 may lack any component that imparts axial kinetic energy to the fluid, thus improving the efficiency of the electric submersible pump and/or reducing its length. Also, because of the smaller diameter of the second gas separator, entrained bubbles may more readily float to the surface, thus improving overall performance of the tandem gas separator system 127.

### ADDITIONAL DISCLOSURE

The following are non-limiting, specific embodiments in accordance with the present disclosure:

In a first embodiment, a gas separator for an electrical submersible pump comprises: a housing defining an inlet at a first axial end of the housing and an outlet at a second axial end of the housing; a drive shaft extending axially through the housing; a fluid reservoir defined by the housing and disposed downstream of the inlet; a paddlewheel affixed to the drive shaft and disposed downstream of the fluid reservoir; and a crossover comprising a skirt, disposed downstream of the paddlewheel, and providing fluid communication between an interior of the housing and an exterior of the housing.

A second embodiment can include the gas separator of the first embodiment, wherein the gas separator does not comprise a rotating component configured to impart axial momentum to fluid.

A third embodiment can include the gas separator of the first or second embodiments, wherein the housing does not contain any rotating components other than the drive shaft and the paddlewheel.

A fourth embodiment can include the gas separator of any of the first through third embodiments, wherein the paddlewheel is axially spaced apart from the skirt of the crossover.

A fifth embodiment can include the gas separator of any of the first through third embodiments, wherein the paddlewheel comprises a notch configured to accommodate at least a portion of the skirt such that an end of the skirt is disposed upstream of an end of the paddlewheel.

A sixth embodiment can include the gas separator of any of the first through fifth embodiments, wherein the crossover comprises a bushing configured to allow the drive shaft to rotate within the crossover.

A seventh embodiment can include the gas separator of any of the first through sixth embodiments, further comprising a spider bearing disposed within the fluid reservoir, wherein the spider bearing is affixed to the housing and configured to allow the drive shaft to rotate within the spider bearing.

In an eighth embodiment, a tandem gas separator system comprises: a first gas separator comprising one or more centrifugal pump stages; and a second gas separator, which is the gas separator of any of the first through seventh embodiments, affixed to the first gas separator such that the housing of the second gas separator is in fluid communication with a housing of the first gas separator, wherein the second gas separator is disposed upstream of the first gas separator, and wherein a diameter of the housing of the second gas separator is less than a diameter of the housing of the first gas separator.

In a ninth embodiment, a method of assembling an electrical submersible pump comprises: coupling the gas separator of any of the first through seventh embodiments to a centrifugal pump assembly and a seal unit; and coupling the seal unit to an electric motor.

In a tenth embodiment, a method of lifting fluid in a wellbore comprises: running an electrical submersible pump into a wellbore, wherein the electrical submersible pump comprises the gas separator of any of the first through seventh embodiments, a centrifugal pump assembly coupled to the gas separator, a seal unit coupled to the gas separator, and an electric motor coupled to the seal unit; and providing power to the electric motor.

In an eleventh embodiment, a gas separator for an electric submersible pump comprises: a housing defining an inlet at a first axial end of the housing and an outlet at a second axial end of the housing; a drive shaft extending axially through the housing; a fluid reservoir defined by the housing and disposed downstream of the inlet; a helical auger affixed to the housing and disposed downstream of the fluid reservoir; and a crossover comprising a skirt, disposed downstream of the helical auger, and providing fluid communication between an interior of the housing and an exterior of the housing.

A twelfth embodiment can include the gas separator of the eleventh embodiment, wherein the gas separator does not comprise a rotating component other than the drive shaft.

A thirteenth embodiment can include the gas separator of the eleventh or twelfth embodiments, wherein the housing does not contain any rotating components other than the drive shaft.

A fourteenth embodiment can include the gas separator of any of the eleventh through thirteenth embodiments, wherein an end of the helical auger is level with an end of the skirt.

A fifteenth embodiment can include the gas separator of any of the eleventh through fourteenth embodiments, wherein the crossover comprises a bushing configured to allow the drive shaft to rotate within the crossover.

A sixteenth embodiment can include the gas separator of any of the eleventh through fifteenth embodiments, further comprising a spider bearing disposed within the fluid reservoir, wherein the spider bearing is affixed to the housing and configured to allow the drive shaft to rotate within the spider bearing.

A seventeenth embodiment can include the gas separator of any of the eleventh through sixteenth embodiments, further comprising a tapered hub disposed at least partially within the helical auger, wherein a pitch angle of the helical auger decreases progressively from a first end of the helical auger to a second end of the helical auger.

In an eighteenth embodiment, a tandem gas separator system comprises: a first gas separator comprising one or more centrifugal pump stages; and a second gas separator, which is the gas separator of any of the eleventh through seventeenth embodiments, affixed to the first gas separator such that the housing of the second gas separator is in fluid communication with a housing of the first gas separator, wherein the second gas separator is disposed upstream of the first gas separator, and wherein a diameter of the housing of the second gas separator is less than a diameter of the housing of the first gas separator.

In a nineteenth embodiment, a method of assembling an electric submersible pump comprises: coupling the gas separator of any of the eleventh through seventeenth embodiments to a centrifugal pump assembly and a seal unit; and coupling the seal unit to an electric motor.

In a twentieth embodiment, a method of lifting fluid in a wellbore comprises: running an electric submersible pump into a wellbore, wherein the electric submersible pump comprises the gas separator of any of the eleventh through seventeenth embodiments, a centrifugal pump assembly coupled to the gas separator, a seal unit coupled to the gas separator, and an electric motor coupled to the seal unit; and providing power to the electric motor.

While embodiments have been shown and described, modifications thereof can be made by one skilled in the art without departing from the spirit and teachings of this disclosure. The embodiments described herein are exemplary only and are not intended to be limiting. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations. For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Disclosure of a singular element should be understood to provide support for a plurality of the element. It is contemplated that elements of the present disclosure may be duplicated in any suitable quantity.

Use of broader terms such as comprises, includes, having, etc. should be understood to provide support for narrower terms such as consisting of, consisting essentially of, comprised substantially of, etc. The use of terms such as “high-pressure” and “low-pressure” is intended to only be descriptive of the component and their position within the systems disclosed herein. That is, the use of such terms should not be understood to imply that there is a specific operating pressure or pressure rating for such components. For example, the term “high-pressure” describing a manifold should be understood to refer to a manifold that receives pressurized fluid that has been discharged from a pump irrespective of the actual pressure of the fluid as it leaves the pump or enters the manifold. Similarly, the term “low-pressure” describing a manifold should be understood to refer to a manifold that receives fluid and supplies that fluid to the suction side of the pump irrespective of the actual pressure of the fluid within the low-pressure manifold.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. Any discussion of a reference herein is not an admission that it is prior art. Any disclosures of all patents, patent applications, and/or publications cited herein are hereby incorporated by reference, to the extent that they provide exemplary, procedural, or other details supplementary to those set forth herein.

As used herein, terms such as parallel, perpendicular, vertical, horizontal, and coincident are not intended to necessarily mean exactly parallel, exactly perpendicular, exactly vertical, exactly horizontal, and exactly coincident. Rather, those terms are intended to mean what those of ordinary skill in the art would recognize as parallel, perpendicular, vertical, horizontal, and coincident. In other words, those and similar terms may cover a structural configuration even when there is some imperfection, variation, or deviation from an exact relationship.

As used herein, the term “or” does not require selection of only one element. Thus, the phrase “A or B” is satisfied by either one or both elements from the set {A, B}. A clause that recites “A or B” can be infringed with only one of the listed items, both of the listed items, multiples of the listed items, and one or both of the listed items and another item not listed. The phrase “A, B, or C” is satisfied by any one or any combination of any two or more from the set {A, B, C}. A clause that recites “A, B, or C” can be infringed with only one of the listed items, multiples of the listed items, and one or more of the items from the list and another item not listed.

As used herein, the article “a” means “one or more.” As used herein, the article “an” means “one or more.” As used herein, the article “the” when referring to a singular noun means “the one or more.” Thus, the phrase “an element” means “one or more elements;” and the phrase “the element” means “the one or more elements.”

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

1-2. (canceled)

3. The tandem gas separator system of claim 8, wherein the housing of the second gas separator does not contain any rotating components other than the drive shaft and the paddlewheel.

4. The tandem gas separator system of claim 8, wherein the paddlewheel is axially spaced apart from the skirt of the crossover.

5. A gas separator for an electrical submersible pump, comprising:
a housing defining an inlet at a first axial end of the housing and an outlet at a second axial end of the housing;
a drive shaft extending axially through the housing;
a fluid reservoir defined by the housing and disposed downstream of the inlet;
a paddlewheel affixed to the drive shaft and disposed downstream of the fluid reservoir; and
a crossover comprising a skirt, disposed downstream of the paddlewheel, and providing fluid communication between an interior of the housing and an exterior of the housing;
wherein the gas separator does not comprise a rotating component configured to impart axial momentum to fluid, and wherein the paddlewheel comprises a notch configured to accommodate at least a portion of the skirt such that an end of the skirt is disposed upstream of an end of the paddlewheel.

6. The tandem gas separator system of claim 8, wherein the crossover comprises a bushing configured to allow the drive shaft to rotate within the crossover.

7. The tandem gas separator system of claim 8, wherein the second gas separator further comprises a spider bearing disposed within the fluid reservoir, wherein the spider bearing is affixed to the housing of the second gas separator and configured to allow the drive shaft to rotate within the spider bearing.

8. A tandem gas separator system, comprising:
a first gas separator comprising one or more centrifugal pump stages; and
a second gas separator affixed to the first gas separator such that a housing of the second gas separator is in fluid communication with a housing of the first gas separator,
wherein the second gas separator is disposed downstream of the first gas separator,
wherein a diameter of the housing of the second gas separator is less than a diameter of the housing of the first gas separator, and
wherein the second gas separator comprises:
the housing of the second gas separator defining an inlet at a first axial end and an outlet at a second axial end;
a drive shaft extending axially through the housing of the second gas separator;
a fluid reservoir defined by the housing of the second gas separator and disposed downstream of the inlet;
a paddlewheel affixed to the drive shaft and disposed downstream of the fluid reservoir; and
a crossover comprising a skirt, disposed downstream of the paddlewheel, and providing fluid communication between an interior of the housing of the second gas separator and an exterior of the housing of the second gas separator;
wherein the second gas separator does not comprise a rotating component configured to impart axial momentum to fluid.

9-13. (canceled)

14. The tandem gas separator system of claim 18, wherein an end of the helical auger is level with an end of the skirt.

15. The tandem gas separator system of claim 18, wherein the crossover of the second gas separator comprises a bushing configured to allow the drive shaft to rotate within the crossover.

16. The tandem gas separator system of claim 18, wherein the second gas separator further comprises a spider bearing disposed within the fluid reservoir, wherein the spider bearing is affixed to the housing of the second gas separator and configured to allow the drive shaft to rotate within the spider bearing.

17. The tandem gas separator system of claim 18, wherein the second gas separator further comprises a tapered hub disposed at least partially within the helical auger, wherein a pitch angle of the helical auger decreases progressively from a first end of the helical auger to a second end of the helical auger.

18. A tandem gas separator system, comprising:
a first gas separator comprising one or more centrifugal pump stages; and
a second gas separator affixed to the first gas separator such that a housing of the second gas separator is in fluid communication with a housing of the first gas separator,
wherein the second gas separator is disposed downstream of the first gas separator,
wherein a diameter of the housing of the second gas separator is less than a diameter of the housing of the first gas separator, and
wherein the second gas separator comprises:
the housing of the second gas separator defining an inlet at a first axial end and an outlet at a second axial end;
a drive shaft extending axially through the housing of the second gas separator;
a fluid reservoir defined by the housing of the second gas separator and disposed downstream of the inlet;
a helical auger affixed to the housing of the second gas separator and disposed downstream of the fluid reservoir; and
a crossover comprising a skirt, disposed downstream of the helical auger, and providing fluid communication between an interior of the housing of the second gas separator and an exterior of the housing of the second gas separator;
wherein the second gas separator does not comprise a rotating component other than the drive shaft or the housing of the second gas separator does not contain any rotating components other than the drive shaft.

19-20. (canceled)

21. The tandem gas separator system of claim 8, wherein:
the first gas separator has a length;
the second gas separator has a length; and
the length of the second gas separator is less than the length of the first gas separator.

22. The tandem gas separator system of claim 18, wherein:
the first gas separator has a length;
the second gas separator has a length; and
the length of the second gas separator is less than the length of the first gas separator.

23. The tandem gas separator system of claim 18, wherein the crossover comprises a spiraled flow path at an upstream end of the crossover, which straightens downstream.

24. The gas separator of claim 5, wherein the housing does not contain any rotating components other than the drive shaft and the paddlewheel.

25. The gas separator of claim 5, further comprising a spider bearing disposed within the fluid reservoir.

26. The gas separator of claim 25, wherein the spider bearing is affixed to the housing and configured to allow the drive shaft to rotate within the spider bearing.

27. The gas separator of claim 5, wherein the crossover comprises a bushing configured to allow the drive shaft to rotate within the crossover.
